(19) United States
(12) Patent Application Publication
(10) Pub. No.: US 2010/0211894 A1
(43) Pub. Date: Aug. 19, 2010

(54) Identifying Object Using Generative Model

(75) Inventors: Michael E. Jahr, San Francisco, CA (US); Uri N. Lerner, Los Altos, CA (US); Noam M. Shazeer, Mountain View, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/388,245

(22) Filed: Feb. 18, 2009

(51) Int. Cl. G06F 17/30; G06F 3/048

(52) U.S. Cl. 715/762

(57) ABSTRACT

Among other disclosed subject matter, a computer-implemented method includes identifying a first object that belongs to a first domain. The method includes identifying, using the first object, at least a first cluster node in a generative model that includes a plurality of first cluster nodes having weighted relationships to respective ones of a plurality of second objects. The method includes identifying, in response to identifying the first object, at least one of the second objects, the second object belonging to the first domain and being identified using the first cluster node and its respective weighted relationship.

### TECHNICAL FIELD

This document relates to information processing.

### BACKGROUND

Some conventional computer systems are configured to work with models. For example, a generative model can be used to output a topic identifier based on input text. Such topic identifier can be an abstract concept relating to one or more words in leaf nodes of the model.

Some conventional computer systems are configured to generate recommendations to a user. For example, at an online bookstore a recommendation to buy a book or other item can be made based on, for example, a previous shopping history of a customer. Also, recommendations are sometimes made to a user based on interests that the user has stated in a signup procedure or other registration.

### SUMMARY

The inventions relates to identifying an object using a generative model.

In a first aspect, a computer-implemented method includes identifying a first object that belongs to a first domain. The method includes identifying, using the first object, at least a first cluster node in a generative model that includes a plurality of first cluster nodes having weighted relationships to respective ones of a plurality of second objects. The method includes identifying, in response to identifying the first object, at least one of the second objects, the second object belonging to the first domain and being identified using the first cluster node and its respective weighted relationship.

Implementations can include any, all or none of the following features. The first cluster node can belong to a second domain and identifying the first cluster node can include mapping from the first object in the first domain to the first cluster node in the second domain. Performing the mapping can include performing an inference operation to the second domain based on the first object. Identifying the second object can include mapping from the first cluster node to the second object. The first cluster node can be associated with a subgroup of the plurality of second objects through at least some of the weighted relationships, and performing the mapping can include evaluating at least one of the weighted relationships. The plurality of cluster nodes can represent abstract concepts and be associated with respective topic identifiers, and the generative model can be a graphical model forming a Bayesian network that links the abstract concepts with respective ones of the second objects. The weighted relationships can include probability values each representing a likelihood that one of the plurality of second objects is present given that at least one of the cluster nodes is present. The plurality of second objects can include screen-viewable execution objects stored in a directory, and the directory can be configured for users to choose any of the second objects and implement a chosen object on a display for viewing. The weighted relationships can represent users' tendencies to place at least two of the screen-viewable execution objects together on a common space. The plurality of second objects can include image objects stored in a directory, and the directory can be configured for users to choose any of the image objects and place a chosen image object in a sketch to form a design. The weighted relationships can represent users' tendencies to place at least two of the image objects together in a common space. The method can further include exchanging the generative model for another generative model configured to have at least the identifying steps performed with regard to another plurality of second objects that belong to the first domain.

In a second aspect, a computer system includes an identifying module identifying a first object that belongs to a first domain. The system includes a first mapper to map from the first object to at least a first cluster node in a generative model that includes a plurality of first cluster nodes having weighted relationships to respective ones of a plurality of second objects. The system includes a second mapper to map, in response to identifying the first object, from the first object to at least one of the second objects, the second object belonging to the first domain and being identified using the first cluster node and the respective weighted relationship.

Implementations can include any, all or none of the following features. The first cluster node can belong to a second domain and the first mapping can be performed from the first object in the first domain to the first cluster node in the second domain, and the 30 first mapper can include an inference engine performing an inference operation to the second domain based on the first object. The first cluster node can be associated with a subgroup of the plurality of second objects through at least some of the weighted relationships, and the second mapper can include a strength evaluator evaluating at least one of the weighted relationships. The system can further include a screen builder configured for users to create a user interface for display; and a directory storing screen-viewable execution objects that comprise the plurality of second objects, the directory configured for users to choose any of the second objects and implement a chosen object on the user interface using the screen builder for viewing. The system can further include a sketch application program configured for users to create a design; and a directory storing image objects that comprise the plurality of second objects, the directory configured for users to choose any of the image objects and place a chosen image object in a sketch to form the design.

Implementations can provide any, all or none of the following advantages. Object identification can provide a more useful output from a generative model. An object in a first domain can be used to identify another object belonging to the same domain in a generative model, via one or more cluster nodes in the generative model having another domain. Improved recommendations generated using a generative model can be provided. Instead of identifying abstract topics related to a query, generative topic models can be generated to identify related objects in the same domain as a query. For example, generative models can be used to make recommendations or broaden a set of objects, in addition to identifying topics.

The details of one or more embodiments are set forth in the accompanying drawings and the description below. Other features and advantages will be apparent from the description and drawings, and from the claims.

### DESCRIPTION OF DRAWINGS

FIGS. 1A-B show an example user interface associated with a system for object identification of gadgets.

FIGS. 2A-B show an example user interface associated with a system for object identification of image objects.

FIG. 3 shows an example generative model.

FIG. 4 shows an example system that can be used for object identification.

FIG. 5 is a flow chart of an example method for identifying an object.

FIG. 6 is a block diagram of a computing system that can be used in connection with computer-implemented methods described in this document.

Like reference symbols in the various drawings indicate like elements.

### DETAILED DESCRIPTION

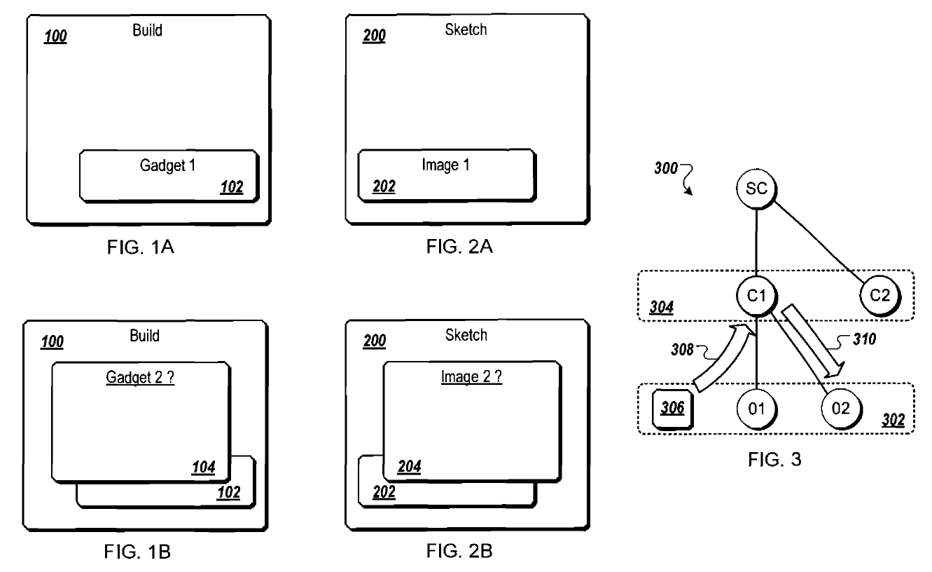

FIGS. 1A-B show an example user interface associated with a system for object identification of gadgets. In this example, a user is working with a computer device that currently presents a user interface 100 on its display. Here, the user interface 100 is generated by a builder application for network resources, such as an HTML editor for creating web pages. The user has started to generate the page by placing a first object 102 (here, “Gadget1”) on the page. The first object 102 can be any kind of object that the user can place on the user interface, such as a “gadget” object that is available from Google Inc. In some implementations, the first object 102 can be a date function or a calendar ticker, to name just a few examples.

The system senses that the first object 102 has been placed on the user's page. In some implementations, this detection can be done during the editing process; for example upon the user completing implementation of the object on the page. In some implementations, the detection can be done later, such as when the user is finished with the builder application and the created page (or other content) is finished.

Upon sensing the object 102, the system can identify one or more other objects to the user. In some implementations, the system can recommend that the user implement also another object or objects, based on the identified first object 102. For example, the system here generates a communication 104 to the user, which provides a way for the user to install a second object (here, “Gadget2”) on the page. That is, the system can recommend the second gadget to the user and provide an implementation control in the communication 104 that the user can employ to install also the second object. For example, upon detecting that the user has installed a date gadget, the system can recommend that the user also install a calendar gadget on the same page. In examples below, it will be described that the identification of the gadget to be recommended, here the second gadget, can be done using a generative model.

If the user wishes to install the second object, the user can click on (or otherwise activate) the implementation control (here, the link “Gadget2?”). This can cause the system to install the second object on the user's page, for example through the builder program. More than one recommendation can be made, and a recommendation can include more than one object. If the user does not wish to install the recommended object(s), the communication 104 can be deleted or otherwise dismissed.

The date and calendar gadgets mentioned above are only two examples. Any kind of executable such as a gadget can be used in some implementations. For example, upon identifying that a certain Japanese blog gadget exists on the page, the system can recommend another Japanese blog gadget. As another example, upon identifying that a certain sports results gadget exists on the page, the system can recommend another sports results gadget. Recommendations can be of objects of the same type (e.g., of another sports results gadget) or of another type (e.g., recommend a breaking-news gadget based on a stock ticker gadget).

FIGS. 2A-B show an example user interface associated with a system for object identification of image objects. In this example, a user is working with a computer device that currently presents a user interface 200 on its display. Here, the user interface 200 is generated by a sketch application for generating layouts, such as a 3D editor for creating interior or exterior designs. The user has started to generate the design by placing a first image object 202 (here, “Image1”) in the layout. The first image object 202 can be any kind of object that the user can place in the layout, such as any of the objects available in the SketchUp modeling program available from Google Inc. In some implementations, the first object 202 can be a building component or a piece of furniture, to name just a few examples.

The system senses that the first object 202 has been placed on the user's layout, for example as described in the earlier example. Upon sensing the object 202, the system can identify one or more other objects to the user, for example as a recommendation. Here, the system generates a communication 204 to the user, which provides a way for the user to install a second object (here, “Image2”) on the page. For example, upon detecting that the user includes a wall or table image, the system can recommend another image, such as a roof or a couch. The image to be recommended can be identified using a generative model, for example as will now be described.

FIG. 3 shows an example generative model 300. The generative model 300 is here a graphical model that connects two or more nodes with each other using links, and thereby maps dependencies and/or other relationships between the nodes. The generative model 300 can include one or more super-cluster nodes (SC) that are at a higher level in the model than another node. In some implementations, the generative model 300 can be a graphical model forming a Bayesian network that links one or more abstract concepts to respective objects.

The generative model 300 can include one or more cluster nodes (C) at a lower level than SC. In this example, a first cluster node (C1) and a second cluster node (C2) are included. In some implementations, the cluster nodes (C1, C2) can represent abstract concepts and can be associated with respective topic identifiers. For example, a cluster node (C1, C2) can represent the abstract concept of correlation between which gadgets users choose to implement on their pages. As another example, a cluster node (C1, C2) can represent the abstract concept of correlation between which image objects users choose to include in their designs. In other implementations, cluster nodes can instead or in addition represent any other concept.

The generative model 300 can include one or more object nodes (O1, O2) associated with another aspect of the model. Here, the object nodes O1 and O2 are associated with the cluster node C1 but not with the cluster node C2. In some implementations, the object node(s) (O1, O2) can be considered leaves in the generative model 300. A link from the cluster node C1 to the object node(s) can represent, for example, a weighted relationship. In some implementations, the weighted relationship represents a likelihood that the node's object is present. For example, the weighted relationship can be a link associated with a probability value, such as between zero and one. Such a probability value, then, can represent a strength of a relationship between the cluster and the node. Other notions of weighted relationships can be used.

Object nodes (O1, O2) can belong to a first domain 302. For example, the first object 102 (FIG. 1) can belong to a domain of screen-viewable execution objects, such as the gadgets mentioned earlier. Similarly, cluster notes (C1, C2) can belong to a domain 304. In some implementations, the cluster nodes are outwardly manifested using their corresponding topic identifiers. For example, the topic identifier can be a series of numbers and/or letters. In such examples, then, the domain 304 can include character strings. Thus, the domains 302 and 304 can be different in some implementations.

In a specific example, a first object 306 is identified. For example, the first object can be any or both of the objects 102 and 202 mentioned above. In this implementation, the generative object model 300 will be consulted using the first object 306 to identify one or more objects to associate with the object 306. Such a consultation can be made in an effort to broaden, in some sense, the scope of the object 306 that has been identified. For example, the object 306 and the generative model 300 can be used to find other objects that are near the object 306 semantically and/or contextually, such that the other object(s) can be recommended as a complement and/or an alternative.

In this example, the object 306 belongs to the domain 302. Based on the object 306, at least one cluster node (C1) of the generative model 300 can be identified. In some implementations, the node C1 can be identified by inference. Thus, the identification can be schematically viewed as a mapping 308 from the object 306 (in the domain 302) to the cluster node C1 (in the domain 304). The mapping 308 can involve extracting or otherwise determining a topic identifier associated with the cluster node. For example, the topic identifier can be a result of performing the inference operation.

The topic identifiers can be useful in the operation of the generative model 300. In some implementations, however, the intended outcome of consulting the generative model 300 is to identify an object in the same domain as the object 306. As another example, the topic identifier associated with the cluster node C1 can represent merely an abstract idea and as such can be less useful as an outcome in some implementations. As yet another example, the same topic identifier can be used in more than one generative model and as such, can be ambiguously associated with different topics.

For the above and/or other reasons, a second mapping 310 can be performed. In some implementations, the second mapping 310 is performed from the cluster node in the domain 304 to one or more objects in the domain 302. Here, for example, the second mapping is performed from the cluster node C1 to the object O2. In some implementations, the second mapping 310 can be performed based on a strength of the relationship between the cluster node C1 and the object O2. In the present example, the identification of the object O2 may be based on a determination that its relationship strength (e.g., the probability linking it to the cluster node C1), satisfies a predefined threshold. The object O1, in contrast, may have been omitted from the second mapping based on a determination that the object O1 does not have a sufficiently strong relationship with the cluster node C1.

In some implementations, methods and techniques for learning a probabilistic generative model described in related U.S. Pat. No. 7,231,393, assigned to the assignee of the present patent application, can be used. For example, the U.S. Pat. No. 7,231,393 describes a system that learns a probabilistic generative model for text. The entire contents of the U.S. Pat. No. 7,231,393 are incorporated herein by reference. In some implementations, the generative model 300 can be trained, for example using teachings in the U.S. Pat. No. 7,231,393, so that the strength relationships between cluster node(s) and object(s) are determined. For example, such training can be performed by providing one or more concepts to form a cluster node and processing sample or representative objects using inference operations to determine strength relationships.

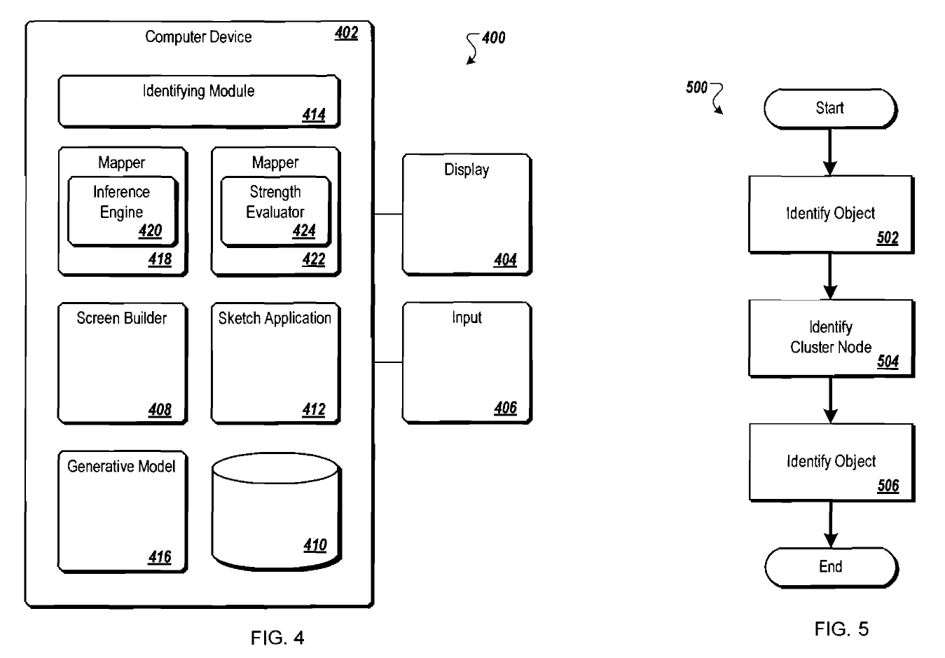

FIG. 4 shows an example system 400 that can be used for object identification. In some implementations, the system 400 can be used with any or all of the examples described above with regard to FIGS. 1A-B, 2A-B and/or 3.

Here, the system 400 includes a computer device 402. The computer device 402 can be a relatively stationary device such as a personal computer or a server, or a relatively mobile device such as a laptop or a cell phone. Other kinds of computer devices can be used. In some implementations, the computer device 402 can be connected to one or more other devices over any kind of network, such as the Internet. A user can interact with the computer device 402 using a display device 404 and/or one or more input devices 406.

Here, the computer device 402 includes a screen builder 408. The screen builder can be a program for editing content such as web pages and/or other forms of content. In some implementations, the screen builder 402 can be a program for implementing screen-viewable execution objects such as the gadgets available from Google, Inc. For example, the screen builder 408 can be used in creating the content shown in FIGS. 1A-B. In some implementations, the gadgets (and/or other items) can be stored in a directory 410. The directory 410 can be configured for users to choose any of the gadgets/items and implement it on a screen for viewing. For example, a user can choose a date gadget and/or a calendar gadget from the directory 410. In some implementations, weighted relationships in the generative model can represent users' tendencies to place at least two of the screen-viewable execution objects (e.g., a date gadget and a calendar gadget) together on a common screen.

Here, the computer device 402 includes a sketch application 412. The sketch application 412 can be a program for generating designs such as 2D or 3D interior or exterior layouts. In some implementations, the sketch application 412 can be a program for assembling image objects such as furniture or house components into a design. For example, the sketch application 412 can include the SketchUp program available from Google Inc. For example, the sketch application 412 can be used in creating the content shown in FIGS. 2A-B. In some implementations, the image object (and/or other items) can be stored in the directory 410. The directory 410 can be configured for users to choose any of the image objects/items and implement it in a layout. For example, a user can choose one or more furniture objects from the directory 410. In some implementations, weighted relationships in the generative model can represent users' tendencies to place at least two of the image objects/items (e.g., a couch image and a table image) together in a common design.

Computer device 402 here includes an identifying module 414. In some implementations, the module 414 can identify one or more objects associated with a user. For example, the identifying module 414 can detect that the user has implemented the first gadget 102 on a page, and/or that the user has included the first image 202 in a design. In some implementations, the identification of an object associated with the user can be done to gather information for making a recommendation to the user, such as to indicate one or more other objects the user may be interested in.

Computer device 402 includes one or more generative models 416. In some implementations, the model(s) 416 can include the generative model 300 and/or the model used to issue the recommendations described in the examples of FIGS. 1A-B or 2A-B.

Computer device 402 includes a first mapper 418. In some implementations, the first mapper 418 can map from an object in a first domain to a cluster node in a second domain. For example, the first mapper 418 can perform the first mapping 308. In some implementations, the first mapper 418 can include an inference engine 420 to perform one or more inference operations. For example, the inference engine 420 can perform an inference, based on information associated with the object, that the object O1 in the domain 302 is related and/or associated with and/or subsumed under the cluster node C1 in the domain 304.

In some implementations, the inference engine 420 can work by one or more of a set of algorithms sometimes used when working with graphical models. For example, given a subset of nodes in a graphical model that are in a known state (e.g. objects in the first domain which are known to be present or absent in the query), an algorithm can produce a probability distribution over other nodes in the model (e.g. cluster nodes in the second domain). Algorithms can include loopy belief propagation and Gibbs sampling.

Here, the computer device 402 can include a second mapper 422. In some implementations, the second mapper 422 can map from a cluster node in a second domain to an object in a first domain. For example, the second mapper 422 can perform the second mapping 3 10. In some implementations, a strength evaluator 424 can be used with the second mapper 422 to evaluate a strength of relationship between a cluster node and one or more objects in the generative model 408, for example using probability values.

One advantage of some implementations is that the output of working with a first generative model can be comparable or consistent with the output obtained from a second generative model. For example, this can be because the output can include one or more of the objects (O1, O2) that are in the same domain as the object associated with the user, as opposed to, say, an abstract concept obtained from the topic identifier of one of the cluster nodes ((C1, C2). Thus, in such implementations, more than one generative model can be used, for example in the system 400. That is, the generative model can be exchanged for another generative model. Optionally, steps of identifying the object 306, identifying the cluster node C1 and identifying the object O1 can then be performed for the other model, with regard to another plurality of second objects that belong to the first domain

FIG. 5 is a flow chart of an example of a method for identifying an object. In some implementations, the method 500 can be performed by a processor performing instructions stored in a computer readable medium, for example in the system 400. In some implementations, more or fewer steps can be performed. As another example, one or more steps can be performed in a different order.

Step 502 involves identifying a first object that belongs to a first domain. For example, the object 102 and/or the object 202 can be identified.

Step 504 involves identifying, using the first object, at least a first cluster node in a generative model. The generative model includes a plurality of first cluster nodes having weighted relationships to respective ones of a plurality of second objects. For example, the cluster node C1 and/or the cluster node C2 can be identified.

Step 506 involves identifying, in response to identifying the first object, at least one of the second objects. The second object belongs to the first domain and is identified using the first cluster node and its respective weighted relationship. For example, the object O1 and/or O2 can be identified.

The identified object can be used in one or more ways. For example, a recommendation such as the recommendation 104 and/or 204 can be made.

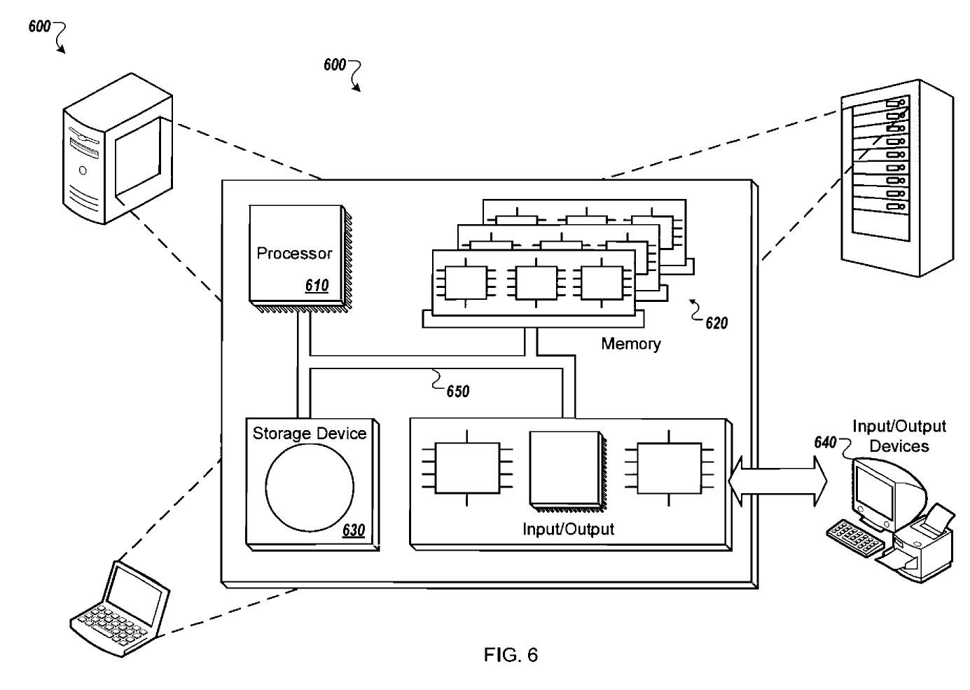

FIG. 6 is a schematic diagram of a generic computer system 600. The system 600 can be used for the operations described in association with any of the computer-implement methods described previously, according to one implementation. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

What is claimed is:

1. A computer-implemented method comprising:
identifying a first object that belongs to a first domain;
identifying, using the first object, at least a first cluster node in a generative model that includes a plurality of first cluster nodes having weighted relationships to respective ones of a plurality of second objects; and
identifying, in response to identifying the first object, at least one of the second objects, the second object belonging to the first domain and being identified using the first cluster node and its respective weighted relationship.

2. The computer-implemented method of claim 1, wherein the first cluster node belongs to a second domain and wherein identifying the first cluster node comprises:
mapping from the first object in the first domain to the first cluster node in the second domain.

3. The computer-implemented method of claim 2, wherein performing the mapping comprises:
performing an inference operation to the second domain based on the first object.

4. The computer-implemented method of claim 1, wherein identifying the second object comprises:
mapping from the first cluster node to the second object.

5. The computer-implemented method of claim 4, wherein the first cluster node is associated with a subgroup of the plurality of second objects through at least some of the weighted relationships, and wherein performing the mapping comprises:
evaluating at least one of the weighted relationships.

6. The computer-implemented method of claim 1, wherein the plurality of cluster nodes represent abstract concepts and are associated with respective topic identifiers, and wherein the generative model is a graphical model forming a Bayesian network that links the abstract concepts with respective ones of the second objects.

7. The computer-implemented method of claim 6, wherein the weighted relationships comprise probability values each representing a likelihood that one of the plurality of second objects is present given that at least one of the cluster nodes is present.

8. The computer-implemented method of claim 1, wherein the plurality of second objects comprise screen-viewable execution objects stored in a directory, wherein the directory is configured for users to choose any of the second objects and implement a chosen object on a display for viewing.

9. The computer-implemented method of claim 8, wherein the weighted relationships represent users' tendencies to place at least two of the screen-viewable execution objects together on a common space.

10. The computer-implemented method of claim 1, wherein the plurality of second objects comprise image objects stored in a directory, wherein the directory is configured for users to choose any of the image objects and place a chosen image object in a sketch to form a design.

11. The computer-implemented method of claim 10, wherein the weighted relationships represent users' tendencies to place at least two of the image objects together in a common space.

12. The computer-implemented method of claim 1, further comprising:
exchanging the generative model for another generative model configured to have at least the identifying steps performed with regard to another plurality of second objects that belong to the first domain.

13. A computer system comprising:
an identifying module identifying a first object that belongs to a first domain;
a first mapper to map from the first object to at least a first cluster node in a generative model that includes a plurality of first cluster nodes having weighted relationships to respective ones of a plurality of second objects; and
a second mapper to map, in response to identifying the first object, from the first object to at least one of the second objects, the second object belonging to the first domain and being identified using the first cluster node and the respective weighted relationship.

14. The computer system of claim 13, wherein the first cluster node belongs to a second domain and the first mapping is performed from the first object in the first domain to the first cluster node in the second domain, and wherein the first mapper comprises:
an inference engine performing an inference operation to the second domain based on the first object.

15. The computer system of claim 13, wherein the first cluster node is associated with a subgroup of the plurality of second objects through at least some of the weighted relationships, and wherein the second mapper comprises:
a strength evaluator evaluating at least one of the weighted relationships.

16. The computer system of claim 13, further comprising:
a screen builder configured for users to create a user interface for display; and
a directory storing screen-viewable execution objects that comprise the plurality of second objects, the directory configured for users to choose any of the second objects and implement a chosen object on the user interface using the screen builder for viewing.

17. The computer system of claim 13, further comprising:
a sketch application program configured for users to create a design; and
a directory storing image objects that comprise the plurality of second objects, the directory configured for users to choose any of the image objects and place a chosen image object in a sketch to form the design.
